(19) United States
(12) Patent Application Publication
(10) Pub. No.: US 2017/0195737 A1
(43) Pub. Date: Jul. 6, 2017

(54) METHOD FOR VIDEO SEARCH AND ELECTRONIC DEVICE

(71) Applicants: Le Holdings (Beijing) Co., Ltd., Beijing (CN); Le Shi Internet Information & Technology Corp., Beijing, Beijing (CN)

(72) Inventor: Renzhong ZHANG, Beijing (CN)

(21) Appl. No.: 15/243,881

(22) Filed: Aug. 22, 2016

Related U.S. Application Data
(63) Continuation of application No. PCT/CN2016/089195, filed on Jul. 7, 2016.

(30) Foreign Application Priority Data
Dec. 30, 2015 (CN) 201511023766.2

(51) Int. Cl. H04N 21/482; H04N 21/431; G06F 17/30; H04N 21/4627

(52) U.S. Cl. CPC H04N 21/4828; H04N 21/4627; H04N 21/4825; H04N 21/4312; G06F 17/3082; G06F 17/30849; G06F 3/0482

(57) ABSTRACT

A method for video search is disclosed. The method includes: at a display device: obtaining a search content inputted into a search box by a user in real time, the search box displayed on the display device; determining target words according to the search content being inputted; searching videos associated with the target words to generate graphic and text information of the videos; displaying the graphic and text information in the form of a pull-down list on the display device; receiving an operation of choosing among the graphic and text information in the pull-down list by the user; and obtaining the corresponding video to play according to the chosen graphic and text information.

### CROSS REFERENCE TO RELATED APPLICATIONS

The present disclosure is a continuation application of PCT International patent application No. PCT/CN2016/089195, filed on Jul. 7, 2016, which claims priority to Chinese Patent Application No. 201511023766.2, filed with the Chinese Patent Office on Dec. 30, 2015, both of which are herein incorporated by reference in its entirety.

### TECHNICAL FIELD

The present disclosure relates to the field of search technology, and particularly, to a method for video search and an electronic device.

### BACKGROUND

With the development of the network technology nowadays, more and more people are acquiring videos via network instead of just watching videos passively like in the past days, and this allows people to obtain the information of video that they want to watch by searching videos. Thus, video search becomes an unavoidable part in acquiring videos. In current search systems, usually a suggest module (i.e., an intelligent prompt module) is included. The suggest module is an optimization module in the search systems and belongs to the technology of interface interaction with users. Before the user inputs the whole or part of search words and clicks on the search button, the suggest module will infer the search words according to the current information (e.g., the spelling, the initial letter, or strokes) inputted by the user and then displays prompt words to the user in the form of a list. As can be known from the above description, the suggest module has two functions: one is to assist the user in inputting, and the other one is to standardize the search words inputted by the user. The suggest module can reduce the time required for inputting the search word by the user through assisting the user in completing the input of the search word, thereby optimizing the searching experience of the user. Meanwhile, searching for invalid words by the user can be prevented by standardizing the search word inputted by the user.

The suggest module infers actual searching demands of the user by means of prefix matching or the like according to the current word inputted by the user, and then displays the inferred prompt words to the user in the form of a list. These prompts words are mainly video albums and star information.

### SUMMARY

An embodiment of the present disclosure provides a method for video search. The method includes: at a display device, obtaining a search content inputted into a search box by a user in real time, the search box displayed on the display device; determining target words according to the search content being inputted; searching videos associated with the target words to generate graphic and text information of the videos; displaying the graphic and text information in the form of a pull-down list on the display device; receiving an operation of choosing among the graphic and text information in the pull-down list by the user; and obtaining the corresponding video to play according to the chosen graphic and text information.

Another embodiment of the present disclosure provides an electronic device. The electronic device includes at least one processor and a memory. The memory is communicably connected with the at least one processor and for storing instructions executable by the at least one processor. Wherein execution of the instructions by the at least one processor causes the at least one processor to:

obtain a search content inputted into a search box by a user in real time;

determine target words according to the search content being inputted;

search videos associated with the target words to generate graphic and text information of the videos;

display the graphic and text information in the form of a pull-down list;

receive an operation of choosing among the graphic and text information in the pull-down list by the user; and

obtain the corresponding video to play according to the chosen graphic and text information.

Still another embodiment of the present disclosure provides a non-transitory computer-readable storage medium. The non-transitory computer-readable storage medium stores executable instructions, wherein when the executable instructions are executed by an electronic device, causes the electronic device to:

obtain a search content inputted into a search box by a user in real time;

determine target words according to the search content being inputted;

search videos associated with the target words to generate graphic and text information of the videos;

display the graphic and text information in the form of a pull-down list;

receive an operation of choosing among the graphic and text information in the pull-down list by the user; and

obtain the corresponding video to play according to the chosen graphic and text information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart diagram of an embodiment of a method for video search according to the present disclosure.

FIG. 2 is a flowchart diagram of another embodiment of a method for video search according to the present disclosure.

FIG. 3 is a schematic diagram of an embodiment of a device for video search according to the present disclosure.

FIG. 4 is a schematic diagram of an embodiment of a video playing terminal according to the present disclosure.

### DETAILED DESCRIPTION

To make the technical solutions and advantages of the present disclosure clearer, the present disclosure will be further detailed with reference to embodiments thereof and the attached drawings.

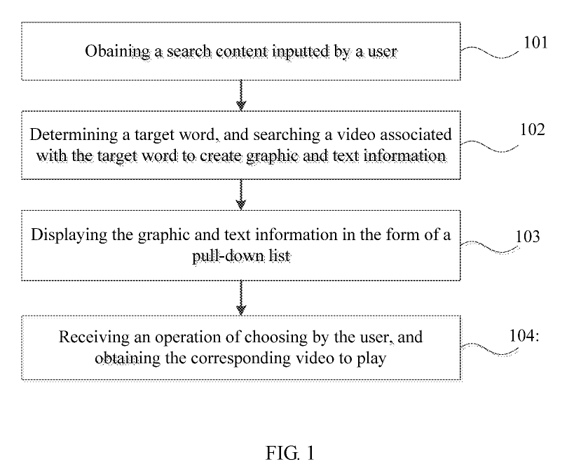

FIG. 1 is a flowchart diagram of an embodiment of a method for video search according to the present disclosure. The method includes the following steps:

Step 101: obtaining in real time a search content inputted into a search box by a user.

The search box is an auxiliary tool used by the user to search videos, e.g., a search box of a search engine or an input box for handwriting input in a mobile phone terminal. When the user is inputting the search content during the searching, the user can achieve the searching by inputting the search content via spelling, strokes or handwriting input, or by inputting the search content via other means such as via voice, remote sensing or the like. The search content is the word or phrase inputted by the user in the aforesaid ways for inputting.

Step 102: determining a target word according to the search content being inputted, and searching a video associated with the target word to create graphic and text information of the video.

Each time a word is inputted or deleted when the user is inputting the search content in the search box, the corresponding target word is determined according to the latest content currently in the search box.

The determination of the target word may be done by suggestion and according to information such as the input habit of the user, the frequency for which the phrase is searched or the popularity of the phrase. A series of phrases or short sentences that the user may want to input are suggested according to the currently latest content, and the phrases or short sentences are determined as the target word inputted by the user. For each target word, videos associated with the target word are acquired by searching to create the graphic and text information of the corresponding video. These graphic and text information is directly linked to the address of the video file. For example, in a mobile terminal, the video corresponding to a certain piece of graphic and text information can be acquired and then displayed by clicking on the graphic and text information. The graphic and text information includes information such as the advertising map, the poster, the video title, associated actors, time of updating or playing of the video, or the like. The user can directly determine whether the video corresponding to the graphic and text information is the one that the user wants to search by checking the graphic and text information.

The creation of the graphic and text information may be achieved by the webpage crawling technology, or each video file may be provided with the corresponding graphic and text information in advance.

The process of searching the corresponding video by means of the target word may include finding the videos of which the title includes the target word according to the title of the video or finding the videos of which the text content in the graphic and text information includes the target word according to the text content in the graphic and text information of the video.

Step 103: displaying the graphic and text information in the form of a pull-down list.

The graphic and text information similarly will be sorted according to information such as the input habit of the user, the frequency for which the phrase is searched or the popularity of the phrase, and then a pull-down box will be popped up below the search box and the graphic and text information is displayed in the pull-down box in the form of a list according to a certain order.

Step 104: receiving an operation of choosing among the graphic and text information in the pull-down list by the user, and obtaining the corresponding video according to the chosen graphic and text information to play the corresponding video.

The user chooses among the graphic and text information in the pull-down box according to his/her searching target, and if the user finds the desired content, then the user chooses the list corresponding to the graphic and text information. The search equipment will determine the graphic and text information corresponding to the location that the user chooses according to the choice of the user, and calls the video corresponding to the graphic and text information to play the video.

As can be known from the above embodiments, the method for video search suggests and determines the target word that the user may input according to the content inputted by the user, and searches the video associated with the target word to create the graphic and text information of the video so that the user can obtain the desired video more conveniently and rapidly. Moreover, the method acquires the graphic and text information of the video corresponding to the target word and directly displays the graphic and text information in the search box so that the user can acquire the specific information of the video more intuitively to further determine whether the video is the one that he/she wants to search. In this way, the speed at which the user searches the video and the search experience of the user are improved, and moreover, the accuracy in video searching by the user is greatly increased.

In at least one embodiment, the method for video search may be applied to online network searching or may be used to search in a particular video resource database. When the video searching is the online searching, a search server acquires the graphic and text information of the video corresponding to the target word via the network, and establishes a network connection between the graphic and text information and the video. When the video searching is searching in a particular video resource database, the search server searches the corresponding video file and the corresponding graphic and text information in the video resource database, and establishes a local connection between the video file that has been found and the corresponding graphic and text information. By clicking on the corresponding graphic and text information, the user can be directly linked to the corresponding video file, i.e., can directly play the video. In this way, the user can search the video rapidly and stably.

In some embodiments, the method further includes:

detecting in real time an adding or deleting operation for the inputted search content performed by the user in the search box;

if the adding or deleting operation have been performed on the search content, acquiring a new search content; and

re-determining a new target word according to the new search content, searching a video associated with the new target word to create graphic and text information of the video, and updating the pull-down list.

The adding or deleting operation for the search content refers to changing the content inputted by the user, which includes both adding something to the content inputted by the user and deleting something from the content inputted by the user. Thus, on one hand, the method for video search can search and display the video information that the user wants to search in time, and on the other hand, the user can correct the inputted content in time according to the graphic and text information displayed in real time to ensure the input accuracy when the user is searching. That is, the efficiency and the accuracy in video searching by the user are greatly improved.

In some embodiments, displaying the graphic and text information in the form of a pull-down list further includes: setting a play icon at a location in the pull-down list that corresponds to the graphic and text information. Receiving an operation of choosing among the graphic and text information in the pull-down list by the user includes: receiving an operation of clicking the graphic and text information in the pull-down list by the user, determining whether the clicking location is within the range of the play icon, and calling the corresponding video according to the chosen graphic and text information to play the corresponding video if the determination result is yes.

By setting the play icon, the user can directly learn whether the video can be played, and moreover, the user can directly play the corresponding video by clicking on the play icon and can also check the specific information of the video by clicking on other parts outside the icon and then decide whether to play the video. In this way, the user obtains more information of the video and is provided with more options, i.e., the search experience of the user is improved.

In some embodiments, after searching a video associated with the target word to create graphic and text information of the video, the method further includes:

acquiring account information of the current user, and determining whether the user has the right to watch the video corresponding to the graphic and text information according to the account information of the user;

if the determination result is yes, setting the play icon at a location in the pull-down list that corresponds to the graphic and text information; and

if the determination result is no, then no play icon is set at the location in the pull-down list that corresponds to the graphic and text information.

The account information of the user refers to information associated with the search server and the video, such as whether the user has logged into the search server, whether the user is a member, the member grade of the user, whether the user has purchased the video or the like. The reason why the user has no right to watch the video may also be that the video are unavailable in the search server. For example, a film has been promoted widely, but no video file corresponding to the film has emerged on the network. Through the analysis and the determination for the account information of the user and the design of the corresponding play icon, the user can be told which videos he/she can watch and which videos he/she cannot watch. In this way, the user will not waste time in clicking on the graphic and text information corresponding to the video that cannot be watched, thereby greatly improving the speed at which the user searches the videos and the accuracy in video searching by the user.

In some embodiments, after searching a video associated with the target word to create graphic and text information of the video, the method further includes:

determining whether the video associated with the target word in a same list includes a plurality of episodes; and

if the determination result is yes, setting icons of the different episodes in the list corresponding to the video, and displaying the icons of the episodes in sequence.

The different episode icons are linked to the corresponding videos respectively. That is, by choosing an episode icon among the different episode icons, the user can choose the video corresponding to the episode icon and finally play the video.

When the video searched by the user is a television play, a film series or a variety show with a plurality of episodes, a single piece of graphic and text information cannot enable the user to obtain the target video (e.g., a certain episode in a television play) accurately. Therefore, icons of different episodes need to be added into the graphic and text information corresponding to the list and be arranged in sequence. On one hand, the user can learn how many episodes the video has via those episode icons, and on the other hand, the user can also accurately obtain the desired video by choosing or clicking on the corresponding episode icon. In this way, the time required for searching a single episode of a video by the user is reduced, and the user experience is improved.

In some embodiments, before displaying the icons of the episodes in sequence, the method further includes:

determining whether all the episodes of the video have been updated;

if the determination result is yes, arranging the episodes of the video in a reverse order of update time with the latest updated episode being arranged on the top; and

if the determination result is no, arranging the episodes of the video in the order in which the episodes are played.

In this way, for the video of which all the episodes have been updated, the episodes of the video simply need to be arranged in the order in which the episodes are played. For the video of which the episodes have not been updated completely, the episodes are arranged in a reverse order; on one hand, the user can directly know which episode of the video has been updated latest; and on the other hand, the user searching the video is generally the user waiting for the updating of the video, so the episode that the user wants to search generally is exactly the latest episode of the video. In this way, by arranging the episodes in different ways, the search experience of the user can be greatly optimized to bring people better search enjoyment.

In some embodiments, when the searched video has too many episodes and the episodes cannot be displayed completely in a list, only the first few episodes and the last few episodes may be listed and the remaining episodes are represented by an icon (e.g., “more”) instead of being listed one by one. In this way, the user can obtain more video information in a limited list space.

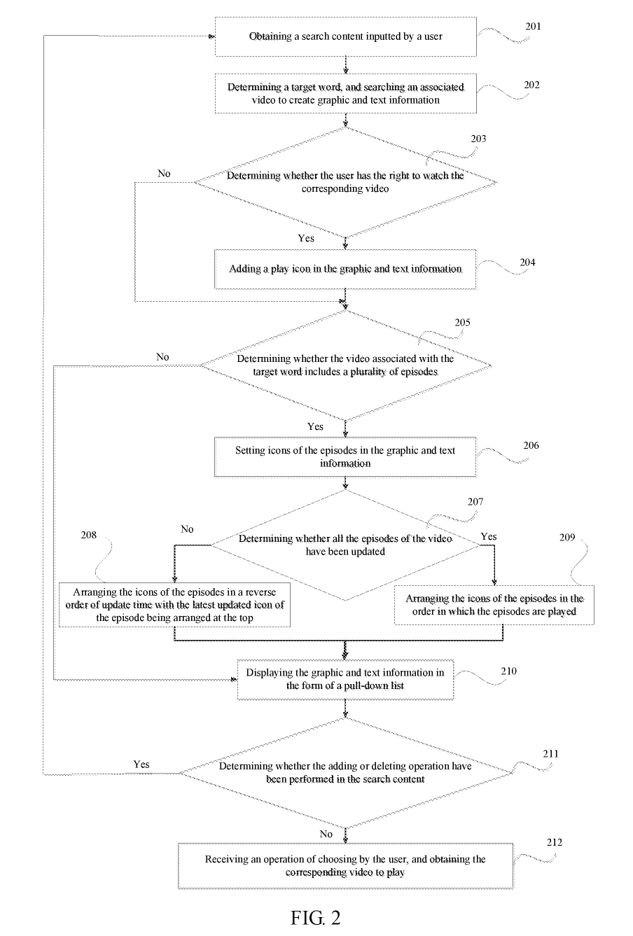

FIG. 2 is a flowchart diagram of another embodiment of a method for video search according to the present disclosure. The method includes the following steps:

Step 201: obtaining a search content inputted by a user. The search content inputted into the search box by the user is acquired in real time.

Step 202: determining a target word and searching an associated video to create graphic and text information. The target word is determined according to the search content being inputted in step 201. The video associated with the target word is searched to create graphic and text information of the video.

Step 203: determining whether the user has the right to watch the corresponding video. The account information of the current user is acquired to determine whether the user has the right to watch the video corresponding to the graphic and text information. If the determination result is yes, turning to step 204; and if the determination result is no, skipping over step 204 and turning to step 205.

Step 204: adding a play icon in the graphic and text information. If the user has the right to watch the video according to step 203, the play icon is set at a location in the pull-down list that corresponds to the graphic and text information.

Step 205: determining whether the video associated with the target word includes a plurality of episodes. If the user has no right to watch the video according to step 203, then no play icon is set at the location in the pull-down list that corresponds to the graphic and text information and it is directly determined whether the video corresponding to the target word includes a plurality of episodes. If it is determined that the video corresponding to the target word includes a plurality of episodes, step 206 is performed; and if it is determined that the video corresponding to the target word does not include a plurality of episodes, step 206, step 207, step 208 and step 209 are skipped over and step 210 is performed.

Step 206: setting icons of the episodes in the graphic and text information. If the video corresponding to the target word includes a plurality of episodes, icons of the different episodes are set in the list corresponding to the graphic and text information.

Step 207: determining whether all the episodes of the video have been updated. It is determined whether all the videos corresponding to the target word have been updated; if the determination result is yes, turning to step 209; and if the determination result is no, turning to step 208.

Step 208: arranging the icons of the episodes in a reverse order of update time with the latest undated icon of the episode being arranged at the top. If the videos corresponding to the target word have not yet been updated completely according to step 207, the icons of the episodes corresponding to the videos are arranged in a reverse order of update time with the latest updated icon of the episode being arranged at the top.

Step 209: arranging the icons of the episodes in the order in which the episodes are played. If all the videos corresponding to the target word have been updated according to step 207, the icons of the episodes corresponding to the videos are arranged in the order in which the episodes are played.

Step 210: displaying the graphic and text information in the form of a pull-down list.

Step 211: determining whether the adding or deleting operation have been performed in the search content. In the search box, the adding or deleting operation for the inputted search content in the search box is detected in real time; if the determination result is yes, turning to step 201; and if the determination result is no, turning to step 212.

Step 212: receiving an operation of choosing by the user, and obtaining the corresponding video to play. The operation of choosing among the graphic and text information in the pull-down list by the user is received. The corresponding video according to the chosen graphic and text information is called to play the corresponding video.

As can be known from the above embodiments, the method for video search allows the user to obtain the information of the searched video more intuitively, rapidly and conveniently, and moreover, allows the user to tell which videos can be played and which videos cannot be played by setting the play icon for the video. Meanwhile, the method for video search allows the user to acquire the desired video more rapidly and directly by setting corresponding episode icons for a plurality of episodes included in the video. Therefore, not only the efficiency and the accuracy of the method for video search are increased, the search experience of the user is also enriched.

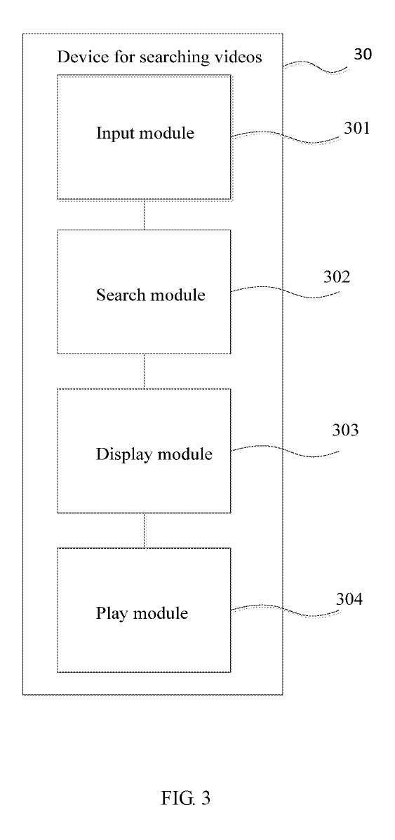

FIG. 3 is a schematic diagram of an embodiment of a device for video search according to the present disclosure. The device 30 includes: an input module 301, a search module 302, a display module 303, and a play module 304.

The input module 301 is configured to acquire in real time a search content inputted into a search box by a user and send the acquired search content to the search module 302.

The search module 302 is configured to receive the search content sent by the input module 301, determine a target word according to the search content being inputted, and search a video associated with the target word to create graphic and text information of the video and send the graphic and text information to the display module 303.

The display module 303 is configured to receive the graphic and text information acquired from the search module 302 and display the graphic and text information in the form of a pull-down list.

The play module 304 is configured to receive an operation of choosing among the graphic and text information in the pull-down list by the user, and call the corresponding video according to the chosen graphic and text information to play the corresponding video.

As can be known from the above embodiments, the device 30 for video search can directly display the video information inputted by the user during the searching via the display module 303, thereby improving the efficiency in video searching by the user. Moreover, the device 30 for video search acquires the graphic and text information of the target video that the user wants to search via the search module 302, so that the user can obtain more specific information of the target video. In this way, the device 30 for video search increases the efficiency and the accuracy in searching videos by the user, and meanwhile greatly enriches the search experience of the user.

In some embodiments, the input module 301 is further configured to detect in real time an adding or deleting operation for the inputted search content performed by the user in the search box, and acquire a new search content and send the new search content to the search module 302 if the adding or deleting operation have been performed on the search content;

the search module 302 is further configured to re-determine a new target word according to the new search content, search a video associated with the new target word to create graphic and text information of the video and send the graphic and text information to the display module 303; and the displaying module 303 is further configured to update the pull-down list after receiving the new graphic and text information sent by the search module 302.

In this way, the device 30 for video search can change accurately in time according to the change in the content inputted by the user during the searching, thereby improving the speed and the efficiency at which the user searches the video.

In some embodiments of the present disclosure, the display module 303 is further configured to set a play icon at a location in the pull-down list that corresponds to the graphic and text information;

in the play module 304, receiving an operation of choosing among the graphic and text information in the pull-down list by the user is a process of receiving an operation of clicking the graphic and text information in the pull-down list by the user, and the play module 304 is further configured to determine whether the clicking location is within the range of the play icon, and call the corresponding video according to the chosen graphic and text information to play the corresponding video if the determination result is yes.

In this way, by setting the play icon, the user can clearly know whether the corresponding video can be played, and moreover, the user can choose to directly play the video or check the specific information of the video, thereby greatly optimizing the search experience of the user.

In some embodiments, the display module 303 is further configured to acquire account information of the current user, and determine whether the user has the right to watch the video corresponding to the graphic and text information according to the account information of the user;

if the determination result is yes, then the play icon is set at a location in the pull-down list that corresponds to the graphic and text information; and

if the determination result is no, then no play icon is set at the location in the pull-down list that corresponds to the graphic and text information.

In this way, by determining whether the user has the right to watch the video and setting the corresponding play icon, users having the right or having no right to watch the video can directly determine whether the video corresponding to the graphic and text information can be played, thereby greatly improving the experience of the user in video searching.

In some embodiments, the display module 303 is further configured to determine whether the video associated with the target word in a same list includes a plurality of episodes; and

if the determination result is yes, then icons of the different episodes are set in the list corresponding to the video, and the icons of the episodes are displayed in sequence. The icons of the different episodes are linked to the corresponding videos respectively.

In some embodiments, the display module 303 is further configured to determine whether all the episodes of the video have been updated;

if the episodes of the video have not been updated completely, then the episodes of the video are arranged in a reverse order of update time with the latest updated episode being arranged at the top; and

if all the episodes of the video have been updated, then the episodes of the video are arranged in the order in which the episodes are played.

In this way, by setting icons for different episodes and arranging the icons of the episodes in a certain order, the user can obtain more information about the video and choose the target video accurately, thereby obtaining better experience in video searching.

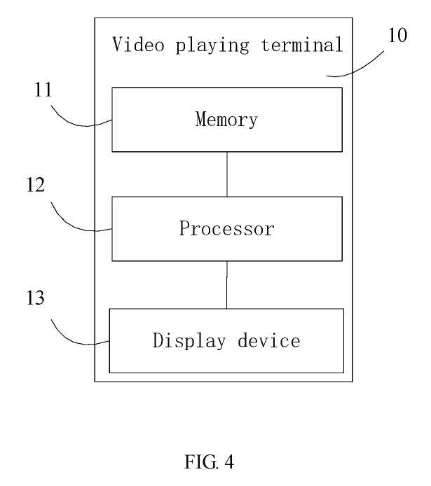

FIG. 4 is a schematic diagram of an embodiment of a video playing terminal 10 according to the present disclosure.

Referring to FIG. 4, the video playing terminal 10 includes: a memory 11, a processor 12, and a display device 13. The memory 11 is configured to store computed executable program instructions. The processor 12 is configured to execute the computed executable program instructions stored in the memory 11, so as to acquire in real time a search content inputted into a search box by a user; determine a target word according to the search content being inputted, and search a video associated with the target word to create graphic and text information of the video; display the graphic and text information in the form of a pull-down list; and receive an operation of choosing among the graphic and text information in the pull-down list by the user, and call the corresponding video according to the chosen graphic and text information to play the corresponding video. The display device 13 is configured to display graphic user interface.

The memory 11 of the video playing terminal 11 may be a non-transitory computed readable storage medium, which is configured to store computed executable program instructions. When the program instructions are executed by one or more central processors, for example, the one or more processors 12 may be caused to perform the steps 101-104 of the method in the above described embodiments of FIG. 1, or the steps 201-212 of the method in the above described embodiments of FIG. 2, or the function of the modules 301-304 of the device 30 in the above described embodiments of FIG. 3.

The computed executable program instructions may be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor storage device. Examples of these storage devices include a magnetic disk, an optical disc based on CD, DVD and Blu-ray technology, and permanent solid memory (for example, a flash memory, a solid driver and the like).

The processor 12 may be a central processing unit (CPU). The processor 12 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

The processor 12 and the memory 11 can, directly or indirectly, be in communication with each other by any appropriate means including, but not limiting to, a bus system or wireless network, so as to achieve data transmitting therebetween. The bus system may include a power bus, a control bus, a state signal bus and the like.

As can be known from the above embodiments, the video playing terminal 10 can perform the method for video search of the above described embodiments of FIGS. 1 and 2, so as to allow the user to obtain the information of the searched video more intuitively and rapidly, and moreover, allows the user to tell which videos can be played and which videos cannot be played by setting the play icon for the video.

Meanwhile, the method for video search allows the user to acquire the desired video more rapidly and directly by setting corresponding episode icons for a plurality of episodes included in the video. Therefore, not only the efficiency and the accuracy of the method for video search are increased, the search experience of the user is also enriched.

As shall be understood by those skilled in the art, various functional units/modules and various steps may be implemented by electrical hardware, computer software, or the combination of both. In order to clearly illustrate the interchangeability of electrical hardware and computer software, the functional units/modules and steps of the above embodiments are described in a general way. Performing the functional units/modules and steps of the above embodiments by means of electrical hardware, computer software, or the combination of both, depends on the specific applications and design constrain conditions of the technical solutions. Those skilled in the art may apply different solutions for each specific application to achieve the functional units/modules and steps of the above embodiments, however, these different solutions should be deemed to be within the scope of the present disclosure. The computer software may be stored in a computed readable storage medium, and can perform the steps of the method in the above described embodiments when being executed. Wherein, the storage medium may be a magnetic disk, an optical disc, a read-only memory, a random memory or the like.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity. Accordingly, any omissions, modifications, equivalent replacements, and alterations within the spirits and principles of the present disclosure shall be included in the scope of the present disclosure.

What is claimed is:

1. A method for video search, comprising:
at an electronic device with a display device;
obtaining a search content inputted into a search box by a user in real time, the search box displayed on the display device;
determining target words according to the search content being inputted;
searching videos associated with the target words to generate graphic and text information of the videos;
displaying the graphic and text information in the form of a pull-down list on the display device;
receiving an operation of choosing among the graphic and text information in the pull-down list by the user; and
obtaining the corresponding video to play according to the chosen graphic and text information.

2. The method according to claim 1, comprising:
detecting an adding or deleting operation on the inputted search content performed by the user in the search box in real time;
obtaining a new search content if the adding or deleting operation have been performed on the search content;
re-determining a new target word according to the new search content;
searching a video associated with the new target word to create graphic and text information of the video, and
updating the pull-down list.

3. The method according to claim 1, wherein displaying the graphic and text information in the form of a pull-down list comprises: setting a play icon at a location that corresponds to the graphic and text information in the pull-down list.

4. The method according to claim 3, wherein receiving an operation of choosing among the graphic and text information in the pull-down list by the user comprises:
receiving an operation of clicking the graphic and text information in the pull-down list by the user;
determining whether the clicking location is within the scope of the play icon; and
obtaining the corresponding video to play according to the chosen graphic and text information if the clicking location is within the scope of the play icon.

5. The method according to claim 3, wherein after searching a video associated with the target words, the method comprises:
obtaining account information of the user;
determining whether the user has the right to watch the video corresponding to the graphic and text information according to the account information of the user;
setting the play icon at a location that corresponds to the graphic and text information in the pull-down list, if the user has the right to watch the video.

6. The method according to claim 1, wherein after searching a video associated with the target words, the method comprises:
determining whether the video associated with the target words in a same list comprises a plurality of episodes;
setting icons of the different episodes in the list corresponding to the video if the video associated with the target words in a same list comprises the plurality of episodes; and
displaying the icons of the episodes in order.

7. The method according to claim 6, wherein before displaying the icons of the episodes in order, the method comprises:
determining whether all the episodes of the video have been updated;
arranging the episodes of the video in a reverse order according to the latest update video, if all the episodes of the video have been updated; and
arranging the episodes of the video sequentially in the order in which the episodes are played if not all the episodes of the video have been updated.

8. An electronic device, comprising:
at least one processor; and
a memory communicably connected with the at least one processor for storing instructions executable by the at least one processor, wherein execution of the instructions by the at least one processor causes the at least one processor to:
obtain a search content inputted into a search box by a user in real time;
determine target words according to the search content being inputted;
search videos associated with the target words to generate graphic and text information of the videos;
display the graphic and text information in the form of a pull-down list;
receive an operation of choosing among the graphic and text information in the pull-down list by the user; and
obtain the corresponding video to play according to the chosen graphic and text information.

9. The electronic device according to claim 8, wherein execution of the instructions by the at least one processor causes the at least one processor to:
detect an adding or deleting operation on the inputted search content performed by the user in the search box in real time;
obtain a new search content if the adding or deleting operation have been performed on the search content;
re-determine a new target word according to the new search content;
search a video associated with the new target word to create graphic and text information of the video, and update the pull-down list.

10. The electronic device according to claim 8, wherein displaying the graphic and text information in the form of a pull-down list comprises: setting a play icon at a location that corresponds to the graphic and text information in the pull-down list.

11. The electronic device according to claim 10, wherein receiving an operation of choosing among the graphic and text information in the pull-down list by the user comprises:
receiving an operation of clicking the graphic and text information in the pull-down list by the user;
determining whether the clicking location is within the scope of the play icon; and
obtaining the corresponding video to play according to the chosen graphic and text information if the clicking location is within the scope of the play icon.

12. The electronic device according to claim 10, wherein after searching a video associated with the target words, execution of the instructions by the at least one processor causes the at least one processor to:
obtain account information of the user;
determine whether the user has the right to watch the video corresponding to the graphic and text information according to the account information of the user; and
set the play icon at a location that corresponds to the graphic and text information in the pull-down list, if the user has the right to watch the video.

13. The electronic device according to claim 8, wherein after searching a video associated with the target words, execution of the instructions by the at least one processor causes the at least one processor to:
determine whether the video associated with the target words in a same list comprises a plurality of episodes;
set icons of the different episodes in the list corresponding to the video if the video associated with the target words in a same list comprises the plurality of episodes; and
display the icons of the episodes in order.

14. The electronic device according to claim 13, wherein before displaying the icons of the episodes in order, execution of the instructions by the at least one processor causes the at least one processor to:
determine whether all the episodes of the video have been updated;
arrange the episodes of the video in a reverse order according to the latest update video, if all the episodes of the video have been updated; and
arrange the episodes of the video sequentially in the order in which the episodes are played if not all the episodes of the video have been updated.

15. A non-transitory computer-readable storage medium storing executable instructions, wherein when executed by an electronic device, causes the electronic device to:
obtain a search content inputted into a search box by a user in real time;
determine target words according to the search content being inputted;
search videos associated with the target words to generate graphic and text information of the videos;
display the graphic and text information in the form of a pull-down list;
receive an operation of choosing among the graphic and text information in the pull-down list by the user; and
obtain the corresponding video to play according to the chosen graphic and text information.

16. The non-transitory computer-readable storage medium according to claim 15, wherein when the executable instructions is executed by the electronic device, causes the electronic device to:
detect an adding or deleting operation on the inputted search content performed by the user in the search box in real time;
obtain a new search content if the adding or deleting operation have been performed on the search content;
re-determine a new target word according to the new search content;
search a video associated with the new target word to create graphic and text information of the video, and
update the pull-down list.

17. The non-transitory computer-readable storage medium according to claim 15, wherein displaying the graphic and text information in the form of a pull-down list comprises: setting a play icon at a location that corresponds to the graphic and text information in the pull-down list.

18. The non-transitory computer-readable storage medium according to claim 17, wherein when the executable instructions is executed by the electronic device, causes the electronic device to: after searching a video associated with the target words,
obtain account information of the user;
determine whether the user has the right to watch the video corresponding to the graphic and text information according to the account information of the user; and
set the play icon at a location that corresponds to the graphic and text information in the pull-down list, if the user has the right to watch the video.

19. The non-transitory computer-readable storage medium according to claim 15, wherein when the executable instructions is executed by the electronic device, causes the electronic device to: after searching a video associated with the target words,
determine whether the video associated with the target words in a same list comprises a plurality of episodes;
set icons of the different episodes in the list corresponding to the video if the video associated with the target words in a same list comprises the plurality of episodes; and
display the icons of the episodes in order.

20. The non-transitory computer-readable storage medium according to claim 19, wherein when the executable instructions is executed by the electronic device, causes the electronic device to: before displaying the icons of the episodes in order,
determine whether all the episodes of the video have been updated;
arrange the episodes of the video in a reverse order according to the latest update video, if all the episodes of the video have been updated; and
arrange the episodes of the video sequentially in the order in which the episodes are played if not all the episodes of the video have been updated.
